(19) United States
(12) Patent Application Publication
(10) Pub. No.: US 2020/0281698 A1
(43) Pub. Date: Sep. 10, 2020

(54) DENTAL IMAGE ACQUISITION APPARATUS AND DENTAL IMAGE ACQUISITION METHOD

(71) Applicant: SONY CORPORATION, TOKYO (JP)

(72) Inventors: HIDEYA CHUBACHI, KANAGAWA (JP); NORIYUKI KISHII, KANAGAWA (JP)

(21) Appl. No.: 16/756,155

(22) PCT Filed: Jul. 12, 2018
(86) PCT No.: PCT/JP2018/026317

§ 371 Date: Apr. 15, 2020

(30) Foreign Application Priority Data
Oct. 24, 2017 (JP) 2017-205060

(51) Int. Cl. A61C 9/00

(52) U.S. Cl. CPC A61C 9/0053; A61C 9/0093

(57) ABSTRACT

Provided is a dental image acquisition apparatus that allows for acquisition of images in a plurality of imaging directions with a single captured image. The dental image acquisition apparatus includes an oral cavity insertion section and an image acquisition section. The oral cavity insertion section is inserted into an oral cavity. The image acquisition section has a light source. The oral cavity insertion section has an imaging unit that includes an imaging section and a light reflection section. The light reflection section is placed at a position opposed to the imaging section via an imaging target. Also, the dental image acquisition apparatus can further include an image processing section and an image display section. The image processing section calculates three-dimensional coordinates of the imaging target on the basis of the image acquired by the image acquisition section. The image display section displays a three-dimensional image created on the basis of the three-dimensional coordinates calculated by the image processing section.

### TECHNICAL FIELD

The present technology relates to a dental image acquisition apparatus and a dental image acquisition method and particularly to a technology of a dental image acquisition apparatus for imaging an oral cavity by using an imaging section inserted into the oral cavity.

### BACKGROUND ART

X-ray photography has been widely used to acquire diagnostic images in dental care. Further, it has become known in recent years to use a CCD camera, a CMOS camera, or other tools for briefing to patients. In the case where dentition or other areas of the oral cavity is imaged by such a camera, it is desirable to use a compact camera of a low manufacturing cost. It should be noted that a still camera or a video camera may be used for imaging.

Here, as a compact and inexpensive apparatus for reading a dentition image, PTL 1 discloses a dentition image reading apparatus that includes an oral cavity insertion section and an imaging optical section. The oral cavity insertion section is inserted between a cheek and dentition. The oral cavity insertion section has a light transmission portion in an area along an outer lateral surface of the dentition and a cavity portion thereinside. The imaging optical section includes a reflecting mirror, scanning means, and imaging optics. The reflecting mirror reflects light from a light source and from the outer lateral surface of the dentition outside of the oral cavity insertion section. The light source can be inserted into the cavity portion of the oral cavity insertion section and emits light to the outer lateral surface of the dentition through the light transmission portion. The scanning means moves the light source and the reflecting mirror along the outer lateral surface of the dentition. The imaging optics receives light reflected by the reflecting mirror.

Also, PTL 2 discloses a dentition image reading apparatus that includes an oral cavity insertion section and an imaging optical section. The oral cavity insertion section is inserted into an oral cavity having maxillary dentition and mandibular dentition. The oral cavity insertion section has a light transmission portion at least on its front or rear side and a cavity portion thereinside. The imaging optical section includes a reflecting mirror, scanning means, and imaging optics. The reflecting mirror reflects light from a light source and from the dentition outside of the oral cavity insertion section. The light source is inserted into the cavity portion of the oral cavity insertion section and emits light to the dentition through the light transmission portion. The scanning means moves the light source and the reflecting mirror along a depth direction inside the cavity portion of the oral cavity insertion section. The imaging optics receives light reflected by the reflecting mirror.

### CITATION LIST

### Patent Literature

[PTL 1]

Japanese Patent Laid-Open No. 2002-191557

[PTL 2]

Japanese Patent Laid-Open No. 2002-125927

### SUMMARY

### Technical Problem

However, the technologies proposed in PTL 1 and PTL 2 are those for reading images of outer lateral surfaces of the dentition. Therefore, the acquisition of images depicting both outer and inner lateral surfaces of dentition is not assumed.

The present technology has been devised in light of the foregoing, and it is a main object of the present technology to provide a dental image acquisition apparatus capable of acquiring images in a plurality of imaging directions with a single captured image.

### Solution to Problem

In order to solve the above problem, a dental image acquisition apparatus of an example of the present technology includes an oral cavity insertion section and an image acquisition section. The oral cavity insertion section is inserted into an oral cavity. The image acquisition section has a light source. The oral cavity insertion section has an imaging unit that includes an imaging section and a light reflection section. The light reflection section is placed at a position opposed to the imaging section via an imaging target. Also, the dental image acquisition apparatus of an example of the present technology can further include an image processing section and an image display section. The image processing section calculates three-dimensional coordinates of the imaging target on the basis of an image acquired by the image acquisition section. The image display section displays a three-dimensional image created on the basis of the three-dimensional coordinates calculated by the image processing section.

Also, a dental image acquisition method of an example of the present technology includes an insertion step, a placement step, and an image acquisition step. In the insertion step, an oral cavity insertion section is inserted into an oral cavity. The oral cavity insertion section has an imaging unit that includes an imaging section and a light reflection section. In the placement step, the light reflection section is placed at a position within a viewing angle of the imaging section via an imaging target. In the image acquisition step, the imaging target is observed with the imaging section, the imaging target is observed from a position opposed to the imaging section with the light reflection section, and an image of the imaging target is acquired.

### Advantageous Effects of Invention

The present technology provides a dental image acquisition apparatus capable of acquiring images in a plurality of imaging directions with a single captured image. It should be noted that the effect of the present technology is not necessarily limited to that described above and may be any one of the effects described in the present disclosure.

### BRIEF DESCRIPTION OF DRAWINGS

FIG. 1 is an overall configuration diagram illustrating a dental image acquisition apparatus of a first embodiment according to the present technology.

FIG. 2 is a schematic diagram illustrating a drive mechanism as seen from a direction A in FIG. 1.

FIG. 3 is a schematic diagram illustrating the drive mechanism as seen from a direction B in FIG. 1.

FIG. 4 is an enlarged schematic diagram illustrating a camera unit depicted in FIG. 1.

FIG. 5 depicts schematic diagrams illustrating the mirror depicted in FIG. 4, in which FIG. 5A is a side view as seen from the side, and FIG. 5B is a plan view as seen from a diagonal direction.

FIG. 6 is a schematic diagram illustrating an example of a captured image captured by a camera unit of the first embodiment according to the present technology.

FIG. 7 depicts schematic diagrams illustrating patterned illumination of illumination optics having a mask of the first embodiment according to the present technology, in which FIG. 7A is a diagram illustrating the illumination optics having the mask and FIG. 7B is a diagram illustrating patterned illumination.

FIGS. 8A to 8C are schematic diagrams illustrating generation of a three-dimensional image by the dental image acquisition apparatus of the first embodiment according to the present technology, in which FIG. 8A is a diagram illustrating a two-dimensional image of a tooth in one direction, FIG. 8B is a diagram illustrating a two-dimensional image of the tooth in another direction, and FIG. 8C is a diagram illustrating a three-dimensional image of the tooth.

FIG. 9 is a flowchart illustrating a dental image acquisition method of the first embodiment according to the present technology.

FIG. 10 is a flowchart illustrating a three-dimensional coordinate acquisition method of the first embodiment according to the present technology.

FIG. 11 is an enlarged schematic diagram illustrating a camera unit of a second embodiment according to the present technology.

FIG. 12 is a schematic diagram illustrating an example of a captured image captured by a camera unit of the second embodiment according to the present technology.

FIG. 13 is an enlarged schematic diagram illustrating a camera unit of a third embodiment according to the present technology.

FIG. 14 is a schematic diagram indicating a point of interest with a laser beam emitted from a camera unit of the third embodiment according to the present technology.

FIG. 15 depicts schematic diagrams illustrating a mirror of a working example using the present technology, in which FIG. 15A is a front view and FIG. 15B is a side view.

FIG. 16 is a schematic diagram illustrating the manner in which an oral cavity is observed with the mirror of the working example using the present technology.

### DESCRIPTION OF EMBODIMENTS

A description will be given below of suitable modes for carrying out the present technology with reference to drawings. It should be noted that embodiments described below merely illustrate typical examples of embodiments of the present technology and that the scope of the present technology is not to be interpreted narrowly because of the embodiments. Also, the present technology permits use of respective embodiments described below and their modification examples in combination.

It should be noted that the description will be given in the following order.

1. Dental image acquisition apparatus of the first embodiment

(1-1) Configuration example of the dental image acquisition apparatus

(1-2) Configuration example of the drive mechanism

(1-3) Configuration example of the camera unit

(1-4) Example of the dental image

(1-5) Example of the dental image acquisition method

(1-6) Example of the three-dimensional coordinate acquisition method

2. Dental image acquisition apparatus of the second embodiment

3. Dental image acquisition apparatus of the third embodiment

4. Working example of the dental image acquisition apparatus to which the present technology is applied

5. Usage example of the dental image acquisition apparatus to which the present technology is applied

### <1. Dental Image Acquisition Apparatus of the First Embodiment>

A description will be given of a dental image acquisition apparatus of a first embodiment according to the present technology by using FIGS. 1 to 10. The dental image acquisition apparatus of the present embodiment is an apparatus used, for example, for root canal treatment that acquires a three-dimensional image (stereoscopic image) by imaging an oral cavity.

### (1-1) Configuration Example of the Dental Image Acquisition Apparatus

A description will be given first of an example of an overall configuration of the dental image acquisition apparatus according to the present embodiment by using FIG. 1. FIG. 1 is an overall configuration diagram illustrating the dental image acquisition apparatus of the first embodiment of the present technology. As illustrated in FIG. 1, a dental image acquisition apparatus 100 of the present embodiment includes an image acquisition section, an image processing apparatus 103, and a monitor 104. The image acquisition section has an oral cavity insertion section 101 and a light source 102. The oral cavity insertion section 101 is inserted into an oral cavity. The image processing apparatus 103 is an image processing section. The monitor 104 is an image display section.

The oral cavity insertion section 101 has a camera unit 105, a drive mechanism 106, and a guide rail 107. The camera unit 105 is a movable imaging unit. The drive mechanism 106 drives the camera unit 105. The guide rail 107 moves the camera unit 105 in an oral cavity. The guide rail 107 is inserted between a cheek and dentition and preferably includes a flexible material. This makes it possible to place the guide rail 107 along dentition of a variety of patients. A power source 108 is provided at one end of the drive mechanism 106. It should be noted that the power source 108 may be a motor or manual means.

The monitor 104 displays a three-dimensional image of an imaging target created on the basis of three-dimensional coordinates calculated by a predetermined calculation. At this time, in the case where observation is made by using near infrared light that penetrates through teeth, it is possible to display, on the monitor 104, an internal structure of a tooth in such a manner that the internal structure overlaps the tooth's appearance. It should be noted that what is displayed on the monitor 104 may be something similar to animation obtained by projecting a three-dimensional structure that connects respective coordinate points of an imaging target onto a two-dimensional plane. Alternatively, what is displayed on the monitor 104 may be something similar to three-dimensional animation obtained by pasting textures.

The camera unit 105 includes a camera 109, a mirror 110, and a connecting section 111. The camera 109 is an imaging section. The mirror 110 is a light reflection section. The connecting section 111 connects the camera 109 and the mirror 110. The mirror 110 is used to observe the tooth from a direction different from that of the camera 109. The camera unit 105 can not only directly observe the tooth but also observe the tooth from two directions with the single camera 109 by capturing the mirror 110 within a field of view of the camera 109, thus allowing for acquisition of three-dimensional coordinates of the tooth.

Further, the dental image acquisition apparatus 100 has a light guide 112 and a camera cable 113. The light guide 112 connects the camera 109 and the light source 102. The camera cable 113 connects the camera 109 and the image processing apparatus 103. Also, as an example, the dental image acquisition apparatus 100 can image dentition 114, which is an imaging target, with the camera 109 and the mirror 110.

### (1-2) Configuration Example of the Drive Mechanism

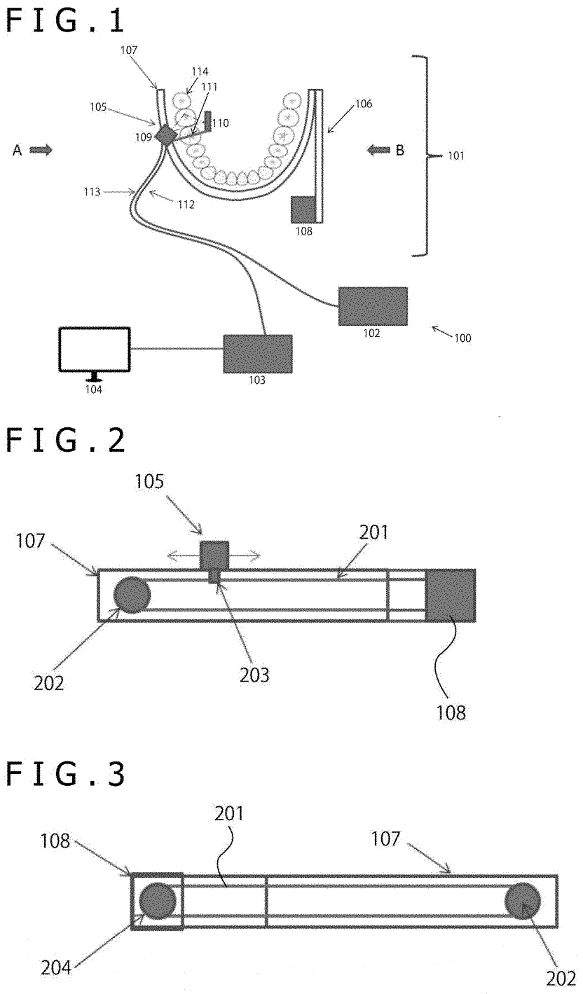

A description will be given next of a configuration example of a drive mechanism of the present embodiment by using FIGS. 2 and 3. FIG. 2 is a schematic diagram illustrating the drive mechanism as seen from a direction A on the left in FIG. 1. FIG. 3 is a schematic diagram illustrating the drive mechanism as seen from a direction B on the right in FIG. 1.

As illustrated in FIG. 2, the drive mechanism 106 of the present embodiment has a wire 201, a traveling pulley 202, and a fixture 203. The wire 201 moves the camera unit 105 on the guide rail 107. The traveling pulley 202 rotates the wire 201 inside the guide rail 107. The fixture 203 fastens the camera unit 105 to any position of the wire 201.

As illustrated in FIG. 3, the drive mechanism 106 of the present embodiment has the wire 201, the traveling pulley 202, the fixture 203, and a driving pulley 204. The traveling pulley 202 is provided at one end of the guide rail 107. The fixture 203 fastens the camera unit 105 which is connected to the power source 108 provided at the other end of the guide rail 107, to any position of the wire 201. The driving pulley 204 is connected to the power source 108.

The dental image acquisition apparatus 100 can successively image each tooth by moving the camera unit 105 along the dentition 114 in the oral cavity with the drive mechanism 106. It should be noted that although the drive mechanism 106 having a wire drive is used in the present embodiment, the drive mechanism according to the present technology is not limited thereto.

### (1-3) Configuration Example of the Camera Unit

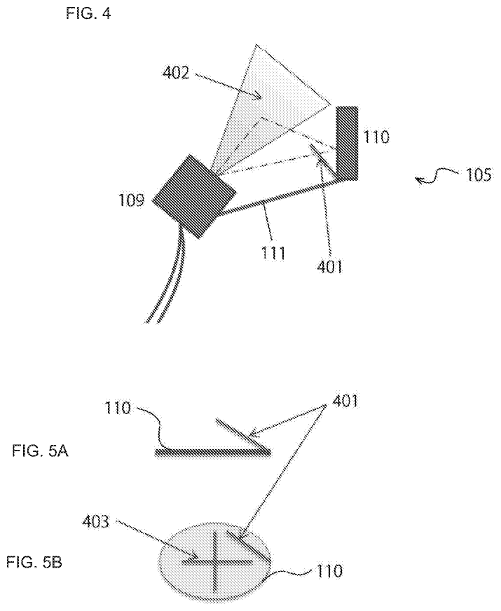

A description will be given next of a configuration example of the camera unit of the present embodiment by using FIGS. 4 and 5. FIG. 4 is an enlarged schematic diagram illustrating the camera unit depicted in FIG. 1. FIG. 5 depicts schematic diagrams illustrating the mirror of the camera unit depicted in FIG. 4. FIG. 5A is a side view as seen from the side of the mirror, and FIG. 5B is a plan view as seen from a diagonal direction.

As illustrated in FIG. 4, the camera unit 105 includes the camera 109, the mirror 110, the connecting section 111 connecting the camera 109 and the mirror 110, and an offset scale 401. The offset scale 401 is a measurement section that protrudes from a mirror surface edge portion of the mirror 110 to an offset position to measure the size of an imaging target. A lens of the camera 109 and the mirror surface of the mirror 110 are placed at opposed positions to face each other via the dentition 114 in the oral cavity. Here, the mirror 110 need only be placed at a position where the imaging target and the mirror surface of the mirror 110 are within a viewing angle of the camera 109 at the same time during imaging. The camera unit 105 can emit illumination light 402 from the light guide 112 toward the imaging target and the mirror surface of the mirror 110 through the surface where the lens of the camera 109 is formed.

As illustrated in FIG. 5A, the offset scale 401 is placed at a position protruding from the mirror surface of the mirror 110 at a predetermined angle. It should be noted that the predetermined angle between the offset scale 401 and the mirror surface of the mirror 110 is preferably 20° to 90° and more preferably 30° or so. Also, as illustrated in FIG. 5B, the mirror 110 is, for example, circular in plan view, and a mirror surface scale 403, which is engraved in a cross shape at the center of the mirror surface, is formed. With the offset scale 401 and the mirror surface scales 403, coordinates of at least five points on the mirror surface of the mirror 110 and at least one point protruding from the mirror surface become known. It should be noted that the camera 109, the mirror 110, and the scales are placed such that at least six reference points (part of the scales) appear in each of a direct view image and a mirror image of the camera 109.

### (1-4) Example of the Dental Image

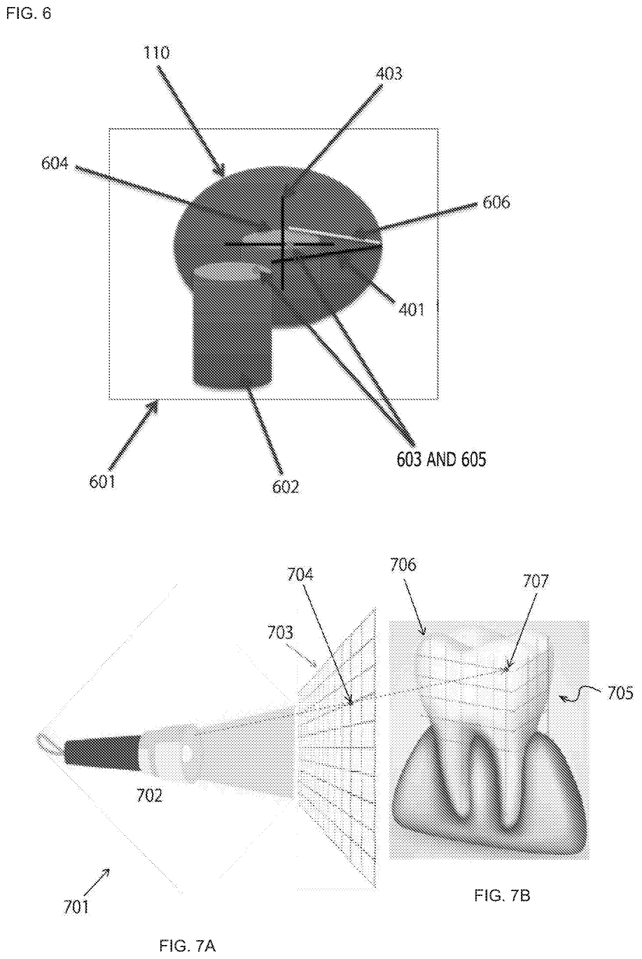

A description will be given next of an example of a dental image that can be captured by the dental image acquisition apparatus 100 of the present embodiment by using FIGS. 6 to 8.

FIG. 6 is a schematic diagram illustrating an example of a captured image captured by the camera unit 105 of the present embodiment. As illustrated in FIG. 6, an imaging target 602, a point of interest 603 of the imaging target 602, the mirror 110, the offset scale 401, and the mirror surface scale 403 appear in a captured image 601. Further, a mirror image 604 of the imaging target 602, a mirror image 605 of the point of interest 603, and a mirror image 606 of the offset scale 401 appear in the mirror 110 in the captured image 601. Here, it is necessary that six points of the offset scale 401 and the mirror surface scale 403 and the point of interest 603 should appear at the same time in both real and mirror images. It should be noted that the camera unit 105 is desirably small enough not to hinder manipulation because of its use in the oral cavity. The mirror surface scales 403 need only be formed such that coordinates of at least six points are known and may be in the shape other than a cross.

FIG. 7 depicts schematic diagrams illustrating patterned illumination of illumination optics having a mask of the present embodiment. FIG. 7A is a diagram illustrating the illumination optics having the mask, and FIG. 7B is a diagram illustrating patterned illumination. As illustrated in FIG. 7A, illumination optics 701 of the present embodiment has an illumination device 702 and a lattice-shaped mask 703. An intersection point of the lattice of the mask 703 can be used as a point of interest 704 as illustrated, for example, in FIG. 7A.

In the case where patterned illumination is conducted by using the illumination optics 701, when illumination light from the illumination device 702 is emitted to the mask 703, a shadow 706 of the mask 703 and a shadow 707 of the point of interest are projected onto the surface of a tooth 705 illustrated in FIG. 7B. As described above, the camera unit 105 has the illumination optics 701 that provides patterned illumination that displays a plurality of points of interest on the surface of an imaging target.

Here, the phrase “having a mask on illumination optics” refers to placing a patterned photomask in an illumination optical path. The photomask has an area that passes light and another area that blocks light, thus allowing projection of a pattern onto an illuminated position like a shadow picture. As described above, using a photomask produces a bright area and a dark area when illuminated. A glass plate with a printed pattern, a mask whose pattern is dynamically varied by using liquid crystal, and the like can be used as a mask. The mask is preferably inserted between the light source (lamp) and an illumination target. It should be noted that a lens may be provided in front or behind of the mask to ensure that an image is properly formed.

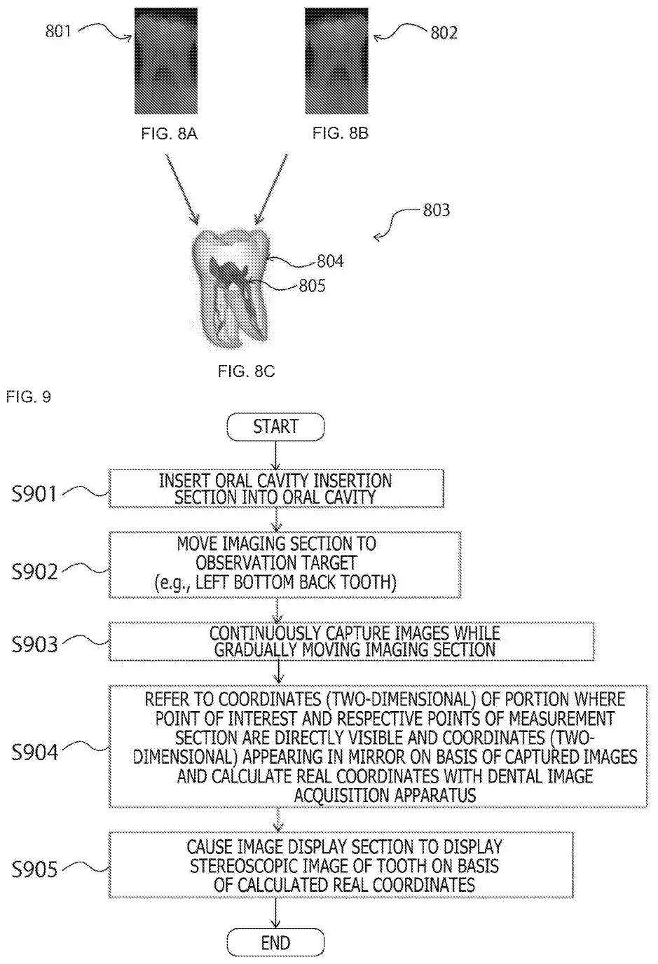

FIGS. 8A to 8C are schematic diagrams illustrating generation of a three-dimensional image by the dental image acquisition apparatus 100 of the present embodiment. FIG. 8A is a diagram illustrating a two-dimensional image 801 of a tooth in one direction, FIG. 8B is a diagram illustrating a two-dimensional image 802 of the tooth in another direction, and FIG. 8C is a diagram illustrating a three-dimensional image 803 of the tooth.

As illustrated in FIGS. 8A and 8B, using visible light during imaging of two-dimensional images 801 and 802 of a tooth with the dental image acquisition apparatus 100 allows for imaging of the appearance of the tooth, and using near infrared light that penetrates through the inside of the tooth allows for imaging of the inside of the tooth. Then, as illustrated in FIG. 8C, it is possible to acquire the three-dimensional image 803 that depicts a tooth surface 804 and an inner part 805 of the tooth such as dental pulp by using the two-dimensional images 801 and 802.

### (1-5) Example of the Dental Image Acquisition Method

A description will be given next of an example of a dental image acquisition method of the present embodiment by using FIG. 9. FIG. 9 is a flowchart illustrating the dental image acquisition method of the present embodiment.

In step S901, the oral cavity insertion section 101 of the dental image acquisition apparatus 100 is inserted into the oral cavity (insertion step).

In step S902, the camera unit 105 of the oral cavity insertion section 101 is moved to an observation position (placement step). Specifically, the mirror 110 is placed at a position in the viewing angle of the camera 109 via the tooth which is an imaging target. In the present embodiment, as an example, the camera unit 105 is moved to the position of the bottom left back tooth.

In step S903, all the imaging targets are imaged continuously while the camera unit 105 is gradually moved from the observation position. In the present embodiment, as an example, the camera unit 105 is gradually moved from the position of the bottom left back tooth toward the front teeth, continuously imaging the teeth until the position of the bottom right back tooth is reached.

In step S904, the image processing apparatus 103 calculates three-dimensional coordinates (real coordinates) on the basis of two-dimensional images captured in step S903 by referring to two-dimensional coordinates of the portion where the point of interest 603 and respective points of the mirror 110 are directly visible and to two-dimensional coordinates appearing in the mirror 110.

In step S905, a three-dimensional image (stereoscopic image) of the tooth is acquired (image acquisition step) on the basis of the three-dimensional coordinates calculated in step S904 and displayed on the monitor 104 which is the image display section.

With the above configuration and action, the dental image acquisition apparatus 100 of the present embodiment can image, with the camera 109, the dentition 114 and the mirror 110 at the same time by placing the camera 109 of the camera unit 105 and the mirror 110 to be opposed to each other with the dentition 114 provided therebetween, thus allowing for acquisition of images of both inner and outer sides of the dentition 114 with the single camera 109. As described above, the dental image acquisition apparatus 100 of the present embodiment allows for acquisition of images in a plurality of imaging directions with a single captured image.

### (1-6) Example of the Three-Dimensional Coordinate Acquisition Method

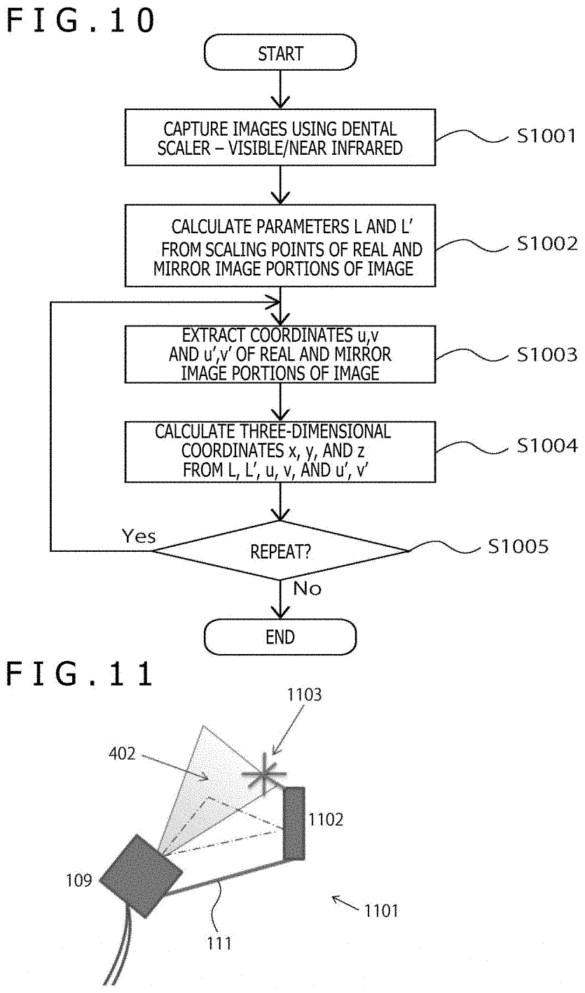

A description will be given next of an example of a three-dimensional coordinate acquisition method of the present embodiment by using FIG. 10. FIG. 10 is a flowchart illustrating an example of the three-dimensional coordinate acquisition method of the present embodiment. In the present embodiment, as an example, actual three-dimensional coordinates are calculated from captured two-dimensional images by using the DLT method which is one of the photogrammetry methods used for aerial photography and other applications.

In step S1001, the imaging target 602 is imaged with visible light and/or near infrared light by using the offset scale 401 of the mirror 110 and the mirror surface scale 403.

In step S1002, real image parameters L (l₁ to l₁₁) and mirror image parameters L′ (l₁′ to l₁₁′) are calculated from scaling points of real and mirror image portions of the captured two-dimensional image by using formulas 1 and 2 given below.

$$\begin{matrix}[ Math . 1 ] & \\ \begin{matrix}\begin{matrix}u \\ h ( v ) \\ 1\end{matrix} = ( \begin{matrix}I 1 & I 2 & I 3 & I 4 \\ I 5 & I 6 & I 7 & I 8 \\ I 9 & I 10 & I 11 & 1\end{matrix} ) ( \begin{matrix}X \\ Y \\ Z \\ 1\end{matrix} ) & ( hQ = LP )\end{matrix} & Formula 1\end{matrix}$$

Formula 1 is a relational formula depicting a relationship between actual coordinates (real coordinates) and coordinates on the image (image coordinates). Formula 1 associates the real coordinates (x, y, z) with the image coordinates (u, v). Here, (u, v) are image coordinates captured with the camera 109, (x, y, z) are real coordinates, and l₁ to l₁₁ are constants (parameters).

$$\begin{matrix} [ Math . 2 ] & \\ ( \begin{matrix}u 1 \\ v 1 \\ u 2 \\ v 2 \\ u 3 \\ v 3 \\ u 4 \\ v 4 \\ u 5 \\ v 5 \\ u 6\end{matrix} ) = ( \begin{matrix}x 1 , y 1 , z 1 , 1 , 0 , 0 , 0 , 0 , - x 1 u 1 , - y 1 u 1 , - z 1 u 1 \\ 0 , 0 , 0 , 0 , x 1 , y 1 , z 1 , 1 , - x 1 v 1 , - y 1 v 1 , - z 1 v 1 \\ x 2 , y 2 , z 2 , 1 , 0 , 0 , 0 , 0 , - x 2 u 2 , - y 2 u 2 , - z 2 u 2 \\ 0 , 0 , 0 , 0 , x 2 , y 2 , z 2 , 1 , - x 2 v 2 , - y 2 v 2 , - z 2 v 2 \\ x 3 , y 3 , z 3 , 1 , 0 , 0 , 0 , 0 , - x 3 u 3 , - y 3 u 3 , - z 3 u 3 \\ 0 , 0 , 0 , 0 , x 3 , y 3 , z 3 , 1 , - x 3 v 3 , - y 3 v 3 , - z 3 v 3 \\ x 4 , y 4 , z 4 , 1 , 0 , 0 , 0 , 0 , - x 4 u 4 , - y 4 u 4 , - z 4 u 4 \\ 0 , 0 , 0 , 0 , x 4 , y 4 , z 4 , 1 , - x 4 v 4 , - y 4 v 4 , - z 4 v 4 \\ x 5 , y 5 , z 5 , 1 , 0 , 0 , 0 , 0 , - x 5 u 5 , - y 5 u 5 , - z 5 u 5 \\ 0 , 0 , 0 , 0 , x 5 , y 5 , z 5 , 1 , - x 5 v 5 , - y 5 v 5 , - z 5 v 5 \\ x 6 , y 6 , z 6 , 1 , 0 , 0 , 0 , 0 , - x 6 u 6 , - y 6 u 6 , - z 6 u 6\end{matrix} ) ( \begin{matrix}\vert 1 \\ \vert 2 \\ \vert 3 \\ \vert 4 \\ \vert 5 \\ \vert 6 \\ \vert 7 \\ \vert 8 \\ \vert 9 \\ \vert 10 \\ \vert 11\end{matrix} ) & Formula 2\end{matrix}$$

Formula 2 is used to calculate the real image parameters L (l₁ to l₁₁) and mirror image parameters L′ (l₁′ to l₁₁′). The real coordinates (x, y, z) are associated with the image coordinates (u, v) by using 11 parameters. The respective parameters L and L′ of the real and mirror images are calculated by substituting real and image coordinate values of the scales into formula 2.

In step S1003, the coordinates (u, v) and (u′, v′) of the real image 603 and the mirror image 605 of the point of interest are extracted by using formulas 3 and 4. It should be noted that a point of interest may be generated automatically.

$$\begin{matrix} [ Math . 3 ] \\ Relational formula of the point of interest on the real image side & \\ ( \begin{matrix}u 1 \\ v 1\end{matrix} ) = ( \begin{matrix}x , y , z , 1 , 0 , 0 , 0 , 0 , - xu 1 , - yu 1 , - zu 1 \\ 0 , 0 , 0 , 0 , x , y , z , 1 , - xv 1 , - yv 1 , - zv 1\end{matrix} ) ( \begin{matrix}I 1 \\ I 2 \\ I 3 \\ I 4 \\ I 5 \\ I 6 \\ I 7 \\ I 8 \\ I 9 \\ I 10 \\ I 11\end{matrix} ) & Formula 3\end{matrix}$$

When the real image parameters L are determined, two simultaneous equations can be obtained from image coordinates (u1, v1) of the real image of the point of interest.

$$\begin{matrix} [ Math . 4 ] \\ Relational formula of the point of interest on the mirror image side & \\ ( \begin{matrix}u 2 \\ v 2\end{matrix} ) = ( \begin{matrix}x , y , z , 1 , 0 , 0 , 0 , 0 , - xu 2 , - yu 2 , - zu 2 \\ 0 , 0 , 0 , 0 , x , y , z , 1 , - xv 2 , - yv 2 , - zv 2\end{matrix} ) ( \begin{matrix}{I}^{′} 1 \\ {I }^{′} 2 \\ {I }^{′} 3 \\ {I }^{′} 4 \\ {I }^{′} 5 \\ {I }^{′} 6 \\ {I }^{′} 7 \\ {I }^{′} 8 \\ {I }^{′} 9 \\ {I }^{′} 10 \\ {I }^{′} 11\end{matrix} ) & Formula 4\end{matrix}$$

Further, when the mirror image parameters L′ are determined, two simultaneous equations can be obtained from image coordinates (u2, v2) of the mirror image of the real image of the point of interest.

In step S1004, the three-dimensional coordinates x, y, and z are calculated from the obtained L, L′, (u, v), and (u′, v′). For example, the coordinates (x, y, z) of the point of interest can be calculated by using the four simultaneous equations obtained from formulas 3 and 4. A three-dimensional image is generated by combining the coordinates that have been obtained.

In step S1005, it is decided whether or not three-dimensional coordinates (x, y, z) of another point of interest are further to be calculated. In the case where three-dimensional coordinates (x, y, z) of another point of interest are to be calculated, the process proceeds to Yes and returns to step S1003. In the case where three-dimensional coordinates (x, y, z) of another point of interest are not to be calculated, the process proceeds to No and is terminated.

Here, in the past, the use of X-ray CT has been known as a method of acquiring three-dimensional coordinates inside a tooth because of the need to stereoscopically see through the tooth. However, X-ray CT is conducted only once before treatment, and progress during treatment cannot be confirmed due to the problem of radiation exposure to the patient and the practitioner. Further, X-ray CT can be used only in an X-ray control area. As a result, it is necessary to prepare a separate inspection room. Also, although a technique is known that permits observation of caries inside the tooth by emitting near infrared light, the observation target is only caries, and the internal structure of the tooth is not subject to observation. Also, such an observation technique does not allow acquisition of three-dimensional coordinates.

In contrast, the dental image acquisition apparatus 100 according to the present embodiment allows for acquisition of images in a plurality of imaging directions with a single captured image by using a mirror and requires only a single camera, thus making it possible to capture two images at the same time with no concern for imaging timings of two cameras. As a result, it is possible to calculate position coordinates with high accuracy.

Also, the dental image acquisition apparatus 100 employs light, thus causing no problem of X-ray exposure during imaging. For this reason, the target can be observed even during treatment, and the treatment can be pursued while at the same time conducting verifications a number of times as necessary, thus ensuring that treatment results remain unaffected by the difference in proficiency between dentists.

Also, in addition to requiring no separate inspection room such as an X-ray control area and causing no risk of X-ray exposure, the dental image acquisition apparatus 100 is compact, allowing for observation of the target on the chair side. It should be noted that the dental image acquisition apparatus 100 can be used as a CAD/CAM oral cavity scanner by measuring the appearance of the oral cavity with the dental image acquisition apparatus 100.

### <2. Dental Image Acquisition Apparatus of the Second Embodiment>

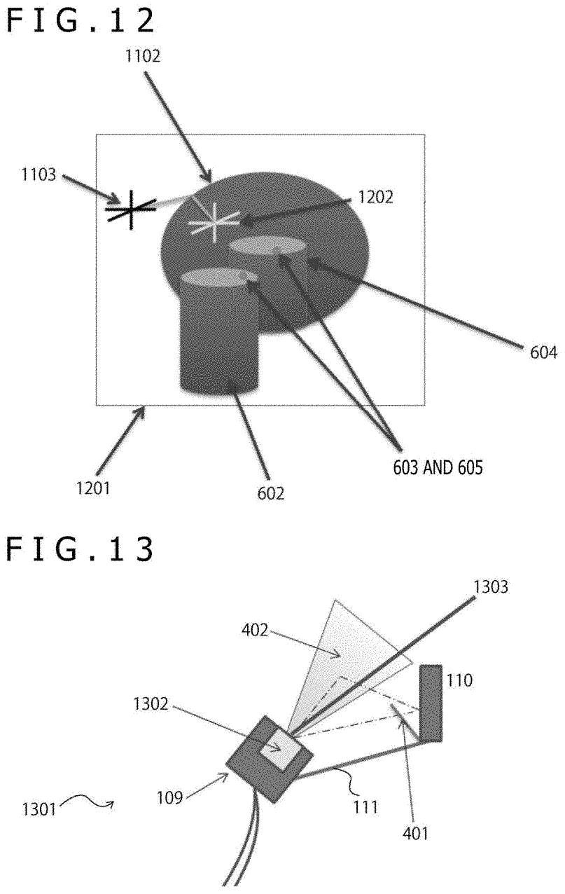

A description will be given of a second embodiment of a dental image acquisition apparatus according to the present technology by using FIGS. 11 and 12. FIG. 11 is an enlarged schematic diagram illustrating a camera unit of the second embodiment according to the present technology. The present embodiment differs from the first embodiment in that the mirror of the camera unit has a scale only at an offset spatial position from the mirror surface. It should be noted that components similar to those of the first embodiment are denoted by the same reference signs and that the description thereof is omitted.

As illustrated in FIG. 11, a camera unit 1101 of the present embodiment includes the camera 109, a mirror 1102, the connecting section 111 connecting the camera 109 and the mirror 1102, and an offset scale 1103 that protrudes from a mirror surface edge portion of the mirror 1102 to an offset spatial position. The lens of the camera 109 and the mirror surface of the mirror 110 are placed at opposed positions to face each other via the dentition 114 in the oral cavity. The camera unit 1101 can emit the illumination light 402 from the light guide 112 toward the imaging target and the mirror surface of the mirror 1102 through the surface where the lens of the camera 109 is formed.

The offset scale 1103 is formed, for example, in the shape of a rod and placed at a position protruding from the mirror surface of the mirror 1102 at a predetermined angle. Further, the offset scale 1103 includes three rod shapes at the tip of the rod shape protruding from the mirror 1102. The three-dimensional coordinates can be measured with respect to the three rod shapes which are orthogonal to each other. It should be noted that the predetermined angle between the offset scale 1103 and the mirror surface of the mirror 1102 is preferably 80° to 120° and more preferably 90° or so.

A description will be given next of an example of a dental image that can be captured by the dental image acquisition apparatus of the present embodiment by using FIG. 12. FIG. 12 is a schematic diagram illustrating an example of a captured image captured by the camera unit 1101 of the present embodiment.

As illustrated in FIG. 12, the imaging target 602, the point of interest 603 of the imaging target 602, the mirror 1102, and the offset scale 1103 appear in a captured image 1201. Further, the mirror image 604 of the imaging target 602, the mirror image 605 of the point of interest 603, and a mirror image 1202 of the offset scale 1103 appear in the mirror 1102 in the captured image 1201. Here, it is necessary that six points of the offset scale 1103 and the point of interest 603 should appear at the same time in both real and mirror images. It should be noted that the six scale points that define the images on the real image side and the mirror image side may be different points as long as they are in the same coordinate system.

The dental image acquisition apparatus of the present embodiment also provides an action and effect similar to those of the dental image acquisition apparatus 100 of the first embodiment by having the camera unit 1101 configured as described above.

### <3. Dental Image Acquisition Apparatus of the Third Embodiment>

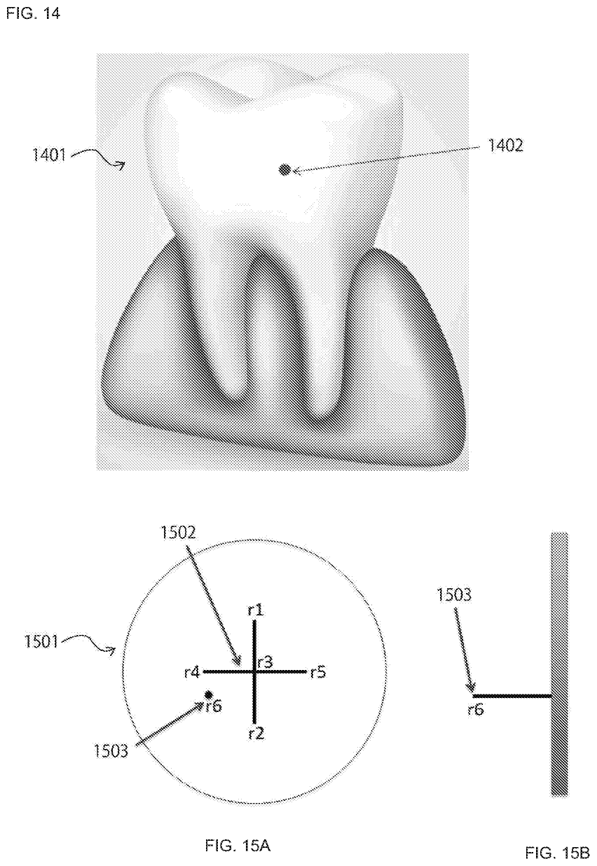

A description will be given of a third embodiment of a dental image acquisition apparatus according to the present technology by using FIGS. 13 and 14. FIG. 13 is an enlarged schematic diagram illustrating a camera unit of the third embodiment according to the present technology. The present embodiment differs from the first embodiment in that a camera of the camera unit has a laser scanning apparatus which is a laser beam source. It should be noted that components similar to those of the first embodiment are denoted by the same reference signs and that the description thereof is omitted.

As illustrated in FIG. 13, a camera unit 1301 of the present embodiment includes the camera 109, the mirror 110, the connecting section 111 connecting the camera 109 and the mirror 110, and the offset scale 401. The offset scale 401 is a measurement section that protrudes from the mirror surface edge portion of the mirror 110 to an offset position to measure the size of an imaging target. The lens of the camera 109 and the mirror surface of the mirror 110 are placed at opposed positions to face each other via the dentition 114 in the oral cavity. The camera unit 11013 can emit the illumination light 402 from the light guide 112 toward the imaging target and the mirror surface of the mirror 1102 through the surface where the lens of the camera 109 is formed.

Further, a laser scanning apparatus 1302 is provided on the lateral surface of the camera 109 of the camera unit 1301. The laser scanning apparatus 1302 can emit a laser beam 1303 in the same direction as the illumination light 402 from the light guide 112.

FIG. 14 is a schematic diagram indicating a point of interest 1402 with a laser beam 1303 emitted from the camera unit 1301 of the present embodiment. The dental image acquisition apparatus of the present embodiment automatically generates the point of interest 1402 as in the first embodiment, thus making it possible to indicate a variety of points by scanning the laser beam 1303 from the laser scanning apparatus 1302. It should be noted that the laser scanning apparatus 1302 may be incorporated in the camera unit 1301 and that a laser beam may be guided by using an optical fiber or other means.

The dental image acquisition apparatus of the present embodiment also provides an action and effect similar to those of the dental image acquisition apparatus 100 of the first embodiment by having the camera unit 1301 having the above configuration.

### <4. Working Example of the Dental Image Acquisition Apparatus to Which the Present Technology is Applied>

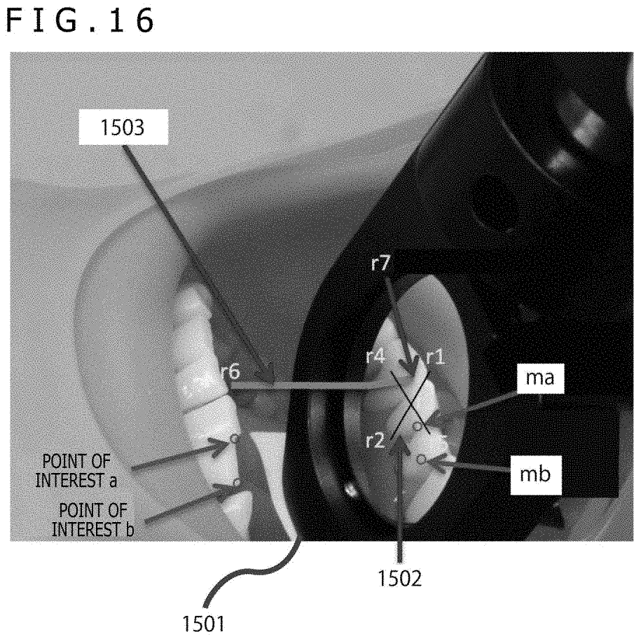

A description will be given of a working example of a dental image acquisition apparatus to which the present technology is applied by using FIGS. 15 and 16. FIG. 15 depicts schematic diagrams illustrating a mirror of the working example using the present technology. FIG. 15A is a front view, and FIG. 15B is a side view. FIG. 16 is a schematic diagram illustrating the manner in which an oral cavity is observed with the mirror of the working example using the present technology. It should be noted that FIG. 16 illustrates a trimmed photograph obtained by removing unnecessary portions from the original photograph.

As illustrated in FIG. 15A, a mirror 1501 of the present working example is circular in plan view. As illustrated in FIGS. 15A and 15B, the mirror 1501 has, at the center on its surface, a mirror surface scale 1502 and an offset scale 1503. The mirror surface scale 1502 has a vertical and horizontal lines with markings that are orthogonal to each other. The offset scale 1503 protrudes perpendicularly from the mirror surface by using a wire. It should be noted that the mirror surface scale 1502 is not limited to one having a vertical and horizontal lines orthogonal to each other and may be one having a vertical and horizontal lines that intersect each other. Also, the offset scale 1503 is not limited to one protruding perpendicularly from the mirror surface and may be one protruding at a given angle. Here, upper and lower tips of the vertical line of the mirror surface scale 1502 are denoted as r1 and r2, left and right tips of the horizontal line are denoted as r3 and r4, and an intersection point of the vertical and horizontal lines is denoted as r5, respectively. Also, a tip of the offset scale 1503 is denoted as r6, and a point on the mirror surface of r6 is denoted as r7.

As illustrated in FIG. 16, imaging is conducted by fastening the camera of the dental image acquisition apparatus of the present embodiment to a human chin and inserting the mirror 1501 into the oral cavity. In the present working example, the DLT method is used to calculate three-dimensional coordinates. Reference points r1 to r6 are used for calculation with the DLT method on the real image, and the reference points r1 to r5 and the point r7 on the mirror surface are used for calculation on the mirror image. Also, three-dimensional coordinates in a real space are calculated from points of interest a and b and mirror images a′ and b′ thereof for comparison with the measured distance. Photograph coordinates obtained from the captured image are illustrated in Table 1.

TABLE 1

| Point | U | V |
|---|---|---|
| a | 1663 | 2321 |
| b | 1675 | 2435 |
| ma | 2148 | 2276 |
| mb | 2153 | 2383 |
| r1 | 2174 | 2137 |
| r2 | 2073 | 2317 |
| r3 | 2120 | 2238 |
| r4 | 2076 | 2161 |
| r5 | 2180 | 2325 |
| r6 | 1641 | 2168 |
| r7 | 2136 | 2147 |

Table 1 represents positions on the shot photograph as pixel positions. For example, Table 1 indicates that the point a is located at the position of the 1663rd pixel to the right and the 2321st pixel down relative to the top left corner of the shot photograph.

The distance between a and b is 4.58 mm from the coordinates of points of interest a (0, 2, 21) and b (2, 6, 23) obtained by the calculation using the DLT method, according to the present working example. In contrast, the measured distance between a and b is 4.7 mm as a result of the measurement using calipers. Therefore, it has been discovered that the calculation result of the distance in the present working example approximately matches the measured value.

### <5. Usage Example of the Dental Image Acquisition Apparatus to Which the Present Technology is Applied>

A description will be given below of an application example in which the dental image acquisition apparatus according to the present technology is applied.

### [Root Canal Treatment]

In root canal treatment, for example, the root canal is spread after pulp extirpation, followed by cleaning and sterilization of the inside and filling of a root canal filling agent. Because of the need for precise treatment, it is necessary to accurately grasp the root canal shape. However, the root canal shape varies from one person to another. Besides, the root canal has a complicated shape. Precise treatment is made possible by seeing through the root canal and grasping the shape thereof in advance by means of the dental image acquisition method according to the present technology. Currently, the inside is observed by using CT. However, CT is conducted only once before treatment due to the risk of X-ray exposure. The dental image acquisition method according to the present technology has no risk of X-ray exposure, thus allowing for observation any number of times during treatment on the chair side and ensuring that treatment results remain unaffected by the difference in proficiency between dentists.

Also, when the inside of a tooth is drilled during caries treatment or root canal treatment, perforation that is erroneous drilling of a hole in a tooth may occur due to miscalculation of the tooth thickness. The present technology has no risk of X-ray exposure, thus allowing for observation any number of times halfway through the treatment and providing a reduced risk of perforation.

### [Cosmetic Dentistry Treatment]

Also, when the teeth alignment is corrected as part of cosmetic dentistry treatment, it is possible to grasp the orientation and position of each tooth, gaps between the teeth, and the like by imaging the dentition as a whole by means of the present technology, thus making it possible to determine a treatment policy, make comparison between before and after the treatment, confirm the progress of the correction, and the like.

### [Application to CAD/CAM Crown]

Further, the present technology can be applied to a CAD/CAM crown. In this case, in the case where a tooth is significantly drilled as part of dental treatment, the tooth is restored by making a crown. The CAD/CAM crown has started to see widespread use in recent years, and the present technology can be used to grasp the shapes of an abutment and an opposing tooth after forming the abutment.

### [Implant Treatment]

In implant treatment, it is necessary to accurately assess the direction in which to insert an implant. The present technology provides a reference for determining a treatment policy as one stereoscopically grasps the dentition as a whole by using the present technology. Also, in implant treatment, a plaster cast of dentition is made in advance, and a jig for determining the insertion direction of the implant is fabricated. However, the present technology makes it possible to fabricate a plaster cast without impression taking.

It should be noted that the present technology also allows for acquisition of three-dimensional coordinates and a three-dimensional image by applying the DLT method using two cameras to dentistry.

It should be noted that embodiments of the present technology are not limited to those described above and can be changed in various ways without departing from the gist of the present technology. For example, it is possible to combine all or some of the plural embodiments described above. Also, the effect described in the present specification is merely illustrative and not restrictive, and there may be other effects.

Also, the present technology can have the following configurations.

(1)

A dental image acquisition apparatus including:
an oral cavity insertion section adapted to be inserted into an oral cavity; and
an image acquisition section having a light source, in which
the oral cavity insertion section has an imaging unit that includes an imaging section and a light reflection section, the light reflection section being placed at a position opposed to the imaging section via an imaging target.
   (2)

The dental image acquisition apparatus of feature (1), in which
the imaging unit is movable.
   (3)

The dental image acquisition apparatus of feature (1) or (2), in which
the oral cavity insertion section further includes a guide rail inserted between a cheek and dentition.
   (4)

The dental image acquisition apparatus of feature (3), in which
the oral cavity insertion section further includes a drive mechanism for driving the imaging unit, and
the drive mechanism moves the imaging unit on the guide rail.
   (5)

The dental image acquisition apparatus of feature (3) or (4), in which
the guide rail includes a flexible material.
   (6)

The dental image acquisition apparatus of any one of features (1) to (5), in which
the light reflection section includes a measurement section for measuring a size of the imaging target.
   (7)

The dental image acquisition apparatus of feature (6), in which
the measurement section protrudes from a reflection surface of at least one point of the light reflection section to an offset position.
   (8)

The dental image acquisition apparatus of any one of features (1) to (7), in which
the light source uses light having a wavelength that penetrates through the imaging target.
   (9)

The dental image acquisition apparatus of any one of features (1) to (8), in which
the light source includes a laser beam source.
   (10)

The dental image acquisition apparatus of any one of features (1) to (9), in which
the imaging unit includes illumination optics having a mask.
   (11)

The dental image acquisition apparatus of feature (10), in which
the imaging unit includes patterned illumination that displays a plurality of points of interest on a surface of the imaging target.
   (12)

The dental image acquisition apparatus of any one of features (1) to (11) further including:
an image processing section adapted to calculate three-dimensional coordinates of the imaging target on the basis of an image acquired by the image acquisition section; and
an image display section adapted to display a three-dimensional image created on the basis of the three-dimensional coordinates calculated by the image processing section.
   (13)

A dental image acquisition method including:
an insertion step of inserting an oral cavity insertion section into an oral cavity, the oral cavity insertion section having an imaging unit that includes an imaging section and a light reflection section;
a placement step of placing the light reflection section at a position within a viewing angle of the imaging section via an imaging target; and
an image acquisition step of observing the imaging target with the imaging section, observing the imaging target from a position opposed to the imaging section with the light reflection section, and acquiring an image of the imaging target.

### REFERENCE SIGNS LIST

100 Dental image acquisition apparatus
101 Oral cavity insertion section
102 Light source
103 Image processing apparatus
104 Monitor
105, 1101, 1301 Camera units
106 Drive mechanism
107 Guide rail
108 Power source
109 Camera
110, 1102, 1501 Mirrors
111 Connecting section
112 Light guide
113 Camera cable
114 Dentition
201 Wire
202, 204 Pulleys
203 Fixture
401, 1103, 1503 Offset scales
402 Illumination light
403, 1502 Mirror surface scales
601, 1201 Captured image
602 Imaging target
603, 704, 1402 Points of interest a and b
604 Mirror image of the imaging target
605, ma, mb Mirror images of the points of interest
606, 1202 Mirror images of the offset scales
701 Illumination optics
702 Illumination device
703 Mask
705, 1401 Teeth
706 Shadow of the mask
707 Shadow of the point of interest
801, 802 Two-dimensional images
803 Three-dimensional image
804 Tooth surface
805 Inner part of the tooth
1302 Laser scanning apparatus
1303 Laser beam

1. A dental image acquisition apparatus comprising:
an oral cavity insertion section adapted to be inserted into an oral cavity; and
an image acquisition section having a light source, wherein
the oral cavity insertion section has an imaging unit that includes an imaging section and a light reflection section, the light reflection section being placed at a position opposed to the imaging section via an imaging target.

2. The dental image acquisition apparatus of claim 1, wherein
the imaging unit is movable.

3. The dental image acquisition apparatus of claim 1, wherein
the oral cavity insertion section further includes a guide rail inserted between a cheek and dentition.

4. The dental image acquisition apparatus of claim 3, wherein
the oral cavity insertion section further includes a drive mechanism for driving the imaging unit, and
the drive mechanism moves the imaging unit on the guide rail.

5. The dental image acquisition apparatus of claim 3, wherein the guide rail includes a flexible material.

6. The dental image acquisition apparatus of claim 1, wherein
the light reflection section includes a measurement section for measuring a size of the imaging target.

7. The dental image acquisition apparatus of claim 6, wherein
the measurement section protrudes from a reflection surface of at least one point of the light reflection section to an offset position.

8. The dental image acquisition apparatus of claim 1, wherein
the light source uses light having a wavelength that penetrates through the imaging target.

9. The dental image acquisition apparatus of claim 1, wherein
the light source includes a laser beam source.

10. The dental image acquisition apparatus of claim 1, wherein
the imaging unit includes illumination optics having a mask.

11. The dental image acquisition apparatus of claim 10, wherein
the imaging unit includes patterned illumination that displays a plurality of points of interest on a surface of the imaging target.

12. The dental image acquisition apparatus of claim 1 further comprising:
an image processing section adapted to calculate three-dimensional coordinates of the imaging target on a basis of an image acquired by the image acquisition section; and
an image display section adapted to display a three-dimensional image created on a basis of the three-dimensional coordinates calculated by the image processing section.

13. A dental image acquisition method comprising:
an insertion step of inserting an oral cavity insertion section into an oral cavity, the oral cavity insertion section having an imaging unit that includes an imaging section and a light reflection section;
a placement step of placing the light reflection section at a position within a viewing angle of the imaging section via an imaging target; and
an image acquisition step of observing the imaging target with the imaging section, observing the imaging target from a position opposed to the imaging section with the light reflection section, and acquiring an image of the imaging target.
